(19) United States
(12) Patent Application Publication
(10) Pub. No.: US 2026/0070695 A1
(43) Pub. Date: Mar. 12, 2026

(54) NOVEL MEMORY-STRUCTURED PERIPHERAL EDGE ROUNDING TECHNOLOGY AND RELATED CONTAINERS

(71) Applicants: Matthew A. Crider, Mansfield, MA (US); John Leone, Lincoln, RI (US); Brian A. Lynch, Merrimack, NH (US); Lawrence E. Jewett, Uxbridge, MA (US)

(72) Inventors: Matthew A. Crider, Mansfield, MA (US); John Leone, Lincoln, RI (US); Brian A. Lynch, Merrimack, NH (US); Lawrence E. Jewett, Uxbridge, MA (US)

(21) Appl. No.: 19/227,139

(22) Filed: Jun. 3, 2025

Related U.S. Application Data
(60) Provisional application No. 63/655,122, filed on Jun. 3, 2024.

(51) Int. Cl. B65D 1/34; B65D 77/20; B65D 81/20

(52) U.S. Cl. CPC B65D 1/34; B65D 77/2024; B65D 81/20; B65D 2543/00537; B65D 2543/00648

(57) ABSTRACT

The present invention is directed to memory-structured (MS) rounded periphery containers, which offer a novel solution for reducing the damage that may be caused by the peripheral edges of containers, and eliminating sharp peripheral edges of thermoformed containers that might otherwise injure flesh, or tear or cut materials that come into contact with the peripheral edge. The memory-structured (MS) rounded periphery containers of the present invention address the residually sharp peripheral edges, for example, of known film sealed containers, without reducing the structural integrity, or strength, at the periphery of the container. Further, the present invention is directed to film sealed memory-structured (MS) rounded periphery containers, which offer a novel solution for reducing the damage that may be caused by the peripheral edges of thermoformed film sealed containers/packaging, and eliminating sharp peripheral edges that might otherwise tear the film seal. The present invention is further directed to related methods and molds for preparing the memory-structured (MS) rounded periphery containers of the present invention.

### RELATED APPLICATIONS

This application claims priority to U.S. Provisional Patent Application No. 63/655,122, filed on Jun. 3, 2024; the entirety of which is incorporated herein by reference.

### BACKGROUND OF THE INVENTION

Film sealed packaging has been a well-established method of sealing and containing foods and foodstuffs within thermoplastic containers. Such containers, including trays, bowls, or bins have been thermoformed, casted, molded or spun into a shape via molten thermoplastic or through preformed thermoplastic sheets that are heated or melted; and then sealed with thin plastic films. Film sealed packaging for use in commercial shipping, storage, display, and sale is often classified as either overwrap packaging, vacuum-sealed packaging, or modified atmosphere packaging. However, these film sealed packages all have historically had a major detraction in that the sharp peripheral edges cause serration of the film over time, and ultimately creates instability and/or a limited lifespan for these containers.

In particular, sharp peripheral edges are often the result of the common finishing technique of trimming of waste material from one or more edges of a shaped article, and leaves a sharp edge that can injure flesh or tear or cut materials that come into contact with the edge. Sealing of such containers typically involves extending or stretching a plastic film across a compartment formed in the container and sealing the film around the periphery of the compartment, depending on the type of film sealed packaging. As such, a peripheral edge that remains sharp, can cut, break, or tear the film upon or after sealing, affecting the proper and consistent sealing of the container.

Shapes and surfaces have been used to reduce the likelihood of punctures or tears in the film of the same or nearby film sealed containers. However, more recent strategies for reducing the sharpness and tendency of thermoformed articles to cause rips, tears, or cuts in the sealing film have included simple displacement of the peripheral edge using both hot and cold processes to reflect the peripheral edge inward. Such processes are not only labor intensive (i.e., often requiring multiple passes of reflection) but also do not actually remove the sharpness of the edge which can still cause injury to flesh or tear or cut materials which come into contact with the sharp peripheral edge. More importantly, the resulting container is weakened at the periphery of the container by the inward reflection process.

As such, there remains a need for new solutions for reducing the sharp peripheral edges of thermoformed containers that can injure flesh, or tear or cut materials that come into contact with the edge. There also remains a need to reduce the sharp peripheral edges of thermoformed film sealed containers/packaging that address the residually sharp peripheral edges of known film sealed container without reducing the structural integrity, or strength, at the periphery of the container.

### SUMMARY OF THE INVENTION

Accordingly, the present invention is directed to memory-structured (MS) rounded periphery containers, which offer a novel solution for reducing the damage that may be caused by the peripheral edges of containers, and eliminating sharp peripheral edges of thermoformed containers that might otherwise injure flesh, or tear or cut materials that come into contact with the peripheral edge. The memory-structured (MS) rounded periphery containers of the present invention address the residually sharp peripheral edges, for example, of known film sealed containers, without reducing the structural integrity, or strength, at the periphery of the container. Further, the present invention is directed to film sealed memory-structured (MS) rounded periphery containers, which offer a novel solution for reducing the damage that may be caused by the peripheral edges of thermoformed film sealed containers/packaging, and eliminating sharp peripheral edges that might otherwise tear the film seal. The present invention is further directed to related methods and molds for preparing the memory-structured (MS) rounded periphery containers of the present invention.

As such, one aspect of the invention provides a memory-structured (MS) rounded periphery container comprising a storage cavity defined by a concave base portion (e.g., a tray or bowl), wherein a memory-structured elbow with an acute angle presented peripherally is positioned between a container rim and a peripheral flange, wherein the peripheral edge of the peripheral flange is deflected toward the periphery of the storage cavity, and the shape of the memory-structured elbow in combination with the deflected peripheral flange produces a rounded periphery of the container.

Another aspect of the invention provides a method of memory-structured peripheral edge rounding of a peripheral edge of a container comprising the steps of: molding a storage cavity defined by a concave base portion comprising a memory-structured elbow with an acute angle presented peripherally is positioned between a container rim and a peripheral flange; deflecting the peripheral edge of the peripheral flange of the storage cavity toward the periphery of the storage cavity, such that the shape of the memory-structured elbow in combination with the deflected peripheral flange produces a rounded periphery of the container.

Another aspect of the invention provides a method of reducing damage to a film seal of a film sealed container comprising the steps of: molding a storage cavity defined by a concave base portion comprising a memory-structured elbow with an acute angle presented peripherally is positioned between a container rim and a peripheral flange; deflecting the peripheral edge of the peripheral flange of the storage cavity toward the periphery of the storage cavity, such that the shape of the memory-structured elbow in combination with the deflected peripheral flange produces a rounded periphery of the container; and applying a film seal to the container (e.g., by overwrapping, vacuum-sealing, or in modified atmosphere).

Yet another aspect of the present invention provides a mold for a memory-structured (MS) rounded periphery container comprising an inverse structure designed to form a storage cavity defined by a concave base portion (e.g., a tray or bowl) through vacuum application to heated thermoplastic, e.g., a thermoplastic sheet, wherein the inverse structure is designed for the creation of the memory-structured elbow with an acute angle presented peripherally positioned between a container rim and a peripheral flange.

Another aspect of the invention provides a film sealed container comprising a memory-structured (MS) rounded periphery container of the present invention; and a film seal (e.g., for overwrapping, for vacuum-sealing, or a modified atmosphere container).

### BRIEF DESCRIPTION OF THE FIGURES

Advantages of the present apparatus will be apparent from the following detailed description, which description should be considered in combination with the accompanying figures, which are not intended to limit the scope of the invention in any way.

FIG. 1 is a side cross-sectional view of half of a storage cavity defined by a concave base portion, wherein a memory-structured elbow with an acute angle presented peripherally is positioned between a container rim and a peripheral flange. An expanded view of the highlighted circle region is also shown.

FIG. 2 is a side cross-sectional view of half of the storage cavity of FIG. 1, wherein the peripheral edge of the peripheral flange is deflected toward the periphery of the storage cavity, and the shape of the memory-structured elbow in combination with the deflected peripheral flange produces a rounded periphery of the memory-structured (MS) rounded periphery containers. An expanded view of the highlighted circle region is also shown, with and without film seal wrapping.

FIG. 3 is a top view perspective of an exemplary storage cavity positioned inside a mold used to create it, defined by a concave base portion and wherein a memory-structured elbow with an acute angle presented peripherally is positioned between a container rim and a peripheral flange.

FIG. 4 is a cross-sectional view of FIG. 3.

FIG. 5 is bottom view perspective of the storage cavity shown in FIG. 3 (as inside the mold).

FIG. 6 is a cross-sectional view of the storage cavity of FIG. 3 positioned inside the molding ram used for deflecting the peripheral edge of the peripheral flange of the storage cavity toward the periphery of the storage cavity to produce a memory-structured (MS) rounded periphery container of the present invention.

FIG. 7 is a top down cross-sectional view of FIG. 6.

FIG. 8 is close-up side angle perspective (flipped upside down from FIGS. 6 and 7) to show the initial positioning of the angled molding ram against the peripheral edge of the flange of the storage cavity of FIG. 6.

FIG. 9 shows the molding ram depicted in FIG. 8, removed and highlighted on its own to assist in visualizing the movement of the storage cavity down/into the first sloped section of the molding ram surface and the transition of the peripheral edge of the flange that strikes the heated molding ram and turns the peripheral edge upwards.

FIG. 10 shows the molding ram depicted in FIGS. 8 and 9, removed and highlighted on its own to assist in visualizing the movement of the storage cavity down/into the horizontal and second sloped sections of the molding ram surface and another section of the peripheral flange deflected peripherally, which simultaneously and consequently turns the upward peripheral edge inward, such that the shape of the deflected memory-structured elbow in combination with the deflected peripheral flange produces a rounded periphery of the container.

FIG. 11 shows a side cross-section angle of the dashed circle highlighted area in FIG. 10 (right side dashed circle) of the deflected peripheral flange superimposed on the molding ram surface in its final position in molding ram, wherein the peripheral edge of the manipulated/deflected peripheral flange has been deflected toward the periphery of the storage cavity, and the shape of the memory-structured elbow in combination with the deflected peripheral flange produces a rounded periphery of the memory-structured (MS) rounded periphery containers.

### DETAILED DESCRIPTION OF THE INVENTION

The containers of the present invention comprise a memory-structured elbow with an acute angle presented peripherally positioned between a container rim and a peripheral flange, wherein the peripheral edge of the peripheral flange is deflected toward the periphery of the storage cavity, and the shape of the memory-structured elbow in combination with the deflected peripheral flange produces a rounded periphery of the container. This memory-structured elbow is created in the molding process and retained in the final shape. This retained elbow structure, in combination with the deflected peripheral flange produces a rounded new periphery of the container.

In certain embodiments of the present invention, the deflection of the peripheral flange in combination with the memory-structured elbow increases the rigidity of the periphery in addition to the rounded periphery that reduces damage that may be caused by the peripheral edges of containers. In particular, such deflection increases structural integrity of the new periphery created, in contrast to a reflected peripheral edge of certain existing/known containers that is created with inward pressure to place the peripheral edge anti-peripheral and towards to the container body.

As such, the present invention is directed to memory-structured (MS) rounded periphery containers, which offer a novel solution for reducing the damage that may be caused by the peripheral edges of containers, and eliminating sharp peripheral edges of thermoformed containers that might otherwise injure flesh, or tear or cut materials that come into contact with the peripheral edge. The memory-structured (MS) rounded periphery containers of the present invention address the residually sharp peripheral edges of known film sealed container without reducing the structural integrity, or strength, at the periphery of the container. Further, the present invention is directed to film sealed memory-structured (MS) rounded periphery containers, which offer a novel solution for reducing the damage that may be caused by the peripheral edges of thermoformed film sealed containers/packaging, and eliminating sharp peripheral edges that might otherwise tear the film seal. The present invention is further directed to related methods and molds for preparing the memory-structured (MS) rounded periphery containers of the present invention.

The present invention, including containers, molds and methods will be described with reference to the following definitions that, for convenience, are set forth below. Unless otherwise specified, the below terms used herein are defined as follows:

### I. Definitions

As used herein, the term “a,” “an,” “the” and similar terms used in the context of the present invention (especially in the context of the claims) are to be construed to cover both the singular and plural unless otherwise indicated herein or clearly contradicted by the context.

The term “about” is used herein in reference to the degree or extent of the term which it modifies, and that such extent may be 100% or near to but not exactly 100% of the modified term; industry accepted standards will assist in defining the quantitative aspects of how “near” 100% is defined. In particular embodiments, the term “about” indicates ±3%, ±2%, ±1% or ±0.5%.

The language “acute angle” is used herein to describe an angle which measures less than 90 degrees. This angle is smaller than the right angle (which is equal to 90 degrees). For example, ∠30°, ∠45°, ∠60°, ∠75°, ∠33°, ∠255°, ∠85°, etc. are all acute angles.

The term “container” is used herein to describe any open (i.e., base storage cavity only) or closable (i.e., base/cover) container configurations comprising at least a storage cavity. In certain embodiments, the container is a film sealed container, e.g., a tray configuration film sealed container.

The term “damage” is used herein to describe the physical harm or injury caused by the peripheral edges of a container to flesh or materials that come into contact with the peripheral edge. In certain embodiments, the damage by the peripheral edge of the container relates to that done to film seal materials positioned on the same or different container. In particular, sharp peripheral edges, which are standard in the container arts, cause rips, tears, or cuts in sealing films, for example, in film sealed packaging/containers. The memory-structured (MS) rounded periphery containers of the present invention provide a reduction in such damage, by incorporating a memory-structured elbow with an acute angle presented peripherally is positioned between a container rim and a peripheral flange, wherein the peripheral edge of the peripheral flange is deflected toward the periphery of the storage cavity, and the shape of the memory-structured elbow in combination with the deflected peripheral flange produces a rounded periphery of the container. In this way, damage (e.g., to the film seal) resulting from the peripheral edges of the memory-structured (MS) rounded periphery containers is reduced (e.g., substantially reduced, e.g., eliminated) as compared with the standard containers in the art.

The term “deflected” or “deflecting” is used herein to describe the initial movement of the peripheral edge of the peripheral flange of a container of the invention caused by interaction with another object, e.g., a ram (e.g., a heated ram) in the direction of the periphery of the container. This deflection is in contrast to causing the initial movement of the peripheral edge toward the container sidewalls, which may be referred to as reflection, and which decreases the structural integrity, or strength, at the periphery of the container. It is still considered deflected even if certain portions of the deflected peripheral edge are subsequently oriented towards the container sidewalls.

The language “film seal container” is art-recognized, and used herein to describe a container in which the container is sealed by a film, e.g., plastic film. In certain embodiments, the film sealed container may be formed using overwrapping, modified atmosphere technology, or vacuum-sealing technology.

The term “imprinting” is art-recognized and is used herein to describe the act of either embossing or debossing a graphic image, e.g., textual, pictorial, or a combination of both. The product of imprinting is an imprint, which is either an embossed or debossed product. Embossing and debossing are techniques used to imprint impressed or depressed images onto material. Embossing produces a raised design, e.g., text or graphic image, which is pressed into material from underneath. Embossing utilizes two dies (a male and female die). In particular embodiments, the imprinting may be printed upon, or the material may be printed upon before imprinting occurs.

The language “memory-structured” is used herein to describe structural features that retain their form (e.g., in significant part), or memory of the original structure, subsequent to physical manipulation of the containers, e.g., by deflection of the peripheral flange. In certain embodiments of the present invention, the memory-structured elbow is retained in the memory-structured (MS) rounded periphery containers of the invention subsequent to manipulation (i.e., deflection) of the peripheral edge of the peripheral flange of the container.

The term “molding” is art-recognized, and is used herein to describe the act of using a mold to cast a three-dimensional shape, e.g., giving a particular shape to something in a molten or plastic state.

The language “peripheral edge” is used herein to describe the outer edge of the flange, i.e., peripheral flange, of the containers of the present invention.

The language “presented peripherally” is used herein to describe the positioning of a feature of the containers, e.g., the acute angle of the memory-structured elbow, facing towards the periphery of the container. In particular, the acute angle of the memory-structured elbow presents its acute angle towards the periphery of the container.

The term “periphery” is used herein to describe the outer or outside three-dimensional physical boundary of the containers as measured as the furthest exterior/outside point in the container. In certain embodiments, prior to deflection, the peripheral edge is the periphery, and when deflected, the shape of the memory-structured elbow in combination with the deflected peripheral flange produces a rounded periphery of the container.

The term “substantially” is used herein in reference to the degree or extent of the term which it modifies, and that such extent is near but not exactly 100%, and industry accepted standards will assist in defining the quantitative aspects of how “near” 100% is defined. For example, as used in the term “substantially reduced,” the term “substantially” would indicate that most of the damage (e.g., to the film seal) resulting from the peripheral edge is eliminated. For example, as used in the term “substantially vertical portion,” the term “substantially” would indicate that the portion is near vertical, or 90 degrees, but only to the extent that the acute angle formed between the substantially vertical portion and the peripheral flange remains acute.

The term “tray” is art-recognized in the container arts, and is used herein to describe the shape of the storage cavity compartment in certain embodiments of the present invention, indicating a flat, shallow container or receptacle with slightly raised side-walls, used for example, for carrying, holding, or displaying articles of food.

### II. Memory-Structured (MS) Rounded Periphery Containers of the Invention

The present invention is directed to memory-structured (MS) rounded periphery containers comprising a storage cavity and a memory-structured elbow positioned between a container rim and a peripheral flange. In particular, the memory-structured elbow comprises an acute angle presented peripherally and is positioned between a container rim and a peripheral flange. The peripheral edge of the peripheral flange is deflected toward the periphery of the storage cavity, and the shape of the memory-structured elbow in combination with the deflected peripheral flange produces a rounded periphery of the container.

The present invention provides a novel solution to reduce the sharpness and tendency of thermoformed articles to cause rips, tears, or cuts in the sealing films, for example in film sealed packaging, where the reduction of damage to the film seal results from memory-structured elbow positioned between a container rim and a peripheral flange such that the shape of the memory-structured elbow in combination with the deflected peripheral flange produces a rounded periphery of the container.

As such, one embodiment of the present invention provides a memory-structured (MS) rounded periphery container comprising
a storage cavity defined by a concave base portion,
   wherein a memory-structured elbow with an acute angle presented peripherally is positioned between a container rim and a peripheral flange, wherein the peripheral edge of the peripheral flange is deflected toward the periphery of the storage cavity, and the shape of the memory-structured elbow in combination with the deflected peripheral flange produces a rounded periphery of the container. In certain embodiments, the memory-structured (MS) rounded periphery container is shaped as a tray or bowl, e.g., single or multi compartment. In particular embodiments, the memory-structured (MS) rounded periphery container is an open container configuration.

In certain embodiments of the present invention, the memory-structured (MS) rounded periphery container is a film sealed container.

In certain embodiments of the present invention, the memory-structured (MS) rounded periphery container is a film sealed container further comprising a film seal used for sealing the container.

In certain embodiments of the present invention, damage to the film seal resulting from the peripheral edge is reduced, e.g., as compared with known/existing standard peripheral flange edges. In particular embodiments, damage to the film seal resulting from the peripheral edge is substantially reduced. In specific embodiments, damage to the film seal resulting from the peripheral edge is eliminated.

Another embodiment of the present invention provides a film sealed container comprising
a memory-structured (MS) rounded periphery container of the present invention; and
a film seal (e.g., for overwrapping, for vacuum-sealing, or for a modified atmosphere container).

In certain embodiments of the present invention, the memory-structured (MS) rounded periphery container is formed from thermoplastic. In certain embodiments, the thermoplastic is in the form of a thermoplastic sheet (e.g., a roll sheet).

In certain embodiments of the present invention, the memory-structured (MS) rounded periphery container is selected from the group consisting or an overwrap container, a vacuum-sealed container, and a modified atmosphere container.

In a particular embodiment, the memory-structured (MS) rounded periphery container is an overwrap container. The overwrap containers of the present invention involve enveloping or wrapping a shaped article (e.g., a thermoformed tray, sheet, bowl, or multi-compartment container) with a thin (often transparent) plastic film after a foodstuff or other item has been placed in the storage cavity, and thereafter sealing the film to itself (e.g., by heating overlapping portions of the film).

In a particular embodiment, the memory-structured (MS) rounded periphery container is a vacuum-sealed container. Vacuum-sealed technology involves adhering a thin (e.g., transparent) plastic film against a face of a shaped container containing a foodstuff (or, for example, a moisture-sensitive object) in the storage cavity. When vacuum-sealed technology is employed, the item(s) to be packaged are placed on a surface or within the storage cavity of the shaped article. The film is overlain such that the item(s) are interposed between the shaped article and the film. Air (or whatever other gases may be present) is withdrawn from the space between the film and the shaped article (optionally in coordination of application of positive pressure to the exterior of one or both of the film and the shaped article) so that the film is closely opposed against the surface of the shaped article and/or the item(s), and the film is sealed (e.g., by way of an interposed adhesive, through heat-induced adhesion, or by static charge adhesion) to the surface of the shaped article across the desired area (usually completely encircling the item(s)). Any excess film can be trimmed from the desired area. The seal may be resistant to gas flow in order to maintain the gas-evacuated state on the interior of the sealed container. The resulting vacuum-sealed container typically has a topology that mimics the shape of the surface of the shaped article having the item(s) thereon.

In a particular embodiment, the memory-structured (MS) rounded periphery container is a modified atmosphere container. Modified atmosphere containers refers to a sealing technology in which a flexible (often transparent) film is sealed (e.g., using heat or an adhesive) about the perimeter of a substantially rigid shaped article. The gases present within the container can be controlled at the time the film is sealed to the article. Thus, if the article and film are sealed in the presence of a selected atmosphere (e.g., a gas, such as one selected to exclude oxygen or to promote fruit ripening), the selected atmosphere can be maintained within the sealed modified atmosphere container during subsequent storage, shipping, and display of the package. In certain embodiments, containers used for modified atmosphere sealing tend to have a planar surface (e.g., a broad, flat rim) surrounding an opening to be sealed by applying a sheet of film against it, sealing the film to the surface (often substantially irreversibly), and then trimming the film about the perimeter of the seal.

The memory-structured (MS) rounded periphery containers of the present invention, are not limited by size or shape, i.e., the containers may be any size or shape, provided the containers comprise a storage cavity and a memory-structured elbow with an acute angle presented peripherally is positioned between a container rim and a peripheral flange. In certain embodiments, the shape of the memory-structured (MS) rounded periphery containers of the present invention may be selected from the group consisting of square, rectangle, round, elliptical, triangular, pentagon, hexagon, octagon, oval, quatrefoil, and curvilinear triangle; wherein the reference to shape describes the two dimensional shape of the primary compartment (e.g., storage cavity) as viewed from the top of the package system, looking downwards. In certain embodiments, these shapes may be formed by arced lines (as compared with straight lines). In particular embodiments, the lower perimeter of the storage cavity is formed with straight lines, and the upper perimeter of the storage cavity is formed with arced lines. In certain embodiments, the memory-structured (MS) rounded periphery container is rectangular. In particular embodiments, the memory-structured (MS) rounded periphery container is tray- or sheet-shaped, e.g., with rounded corners.

The memory-structured (MS) rounded periphery containers of the present invention may comprise any material suitable to achieve the purposes of the invention. In certain embodiments, the material may be selected from resins or plastic materials such as polyethylene, polypropylene, polyvinyl chloride or polyethylene terephthalate (“PETE”), as well as other suitable materials or combinations thereof.

In certain embodiments of the invention, the memory-structured (MS) rounded periphery container is comprised of plastic, e.g., clear/see-through or opaque plastic.

In certain embodiments of the invention, the memory-structured (MS) rounded periphery container is designed to be clear for ease of view of the containment area, e.g., PETE.

In certain embodiments of the present invention, the memory-structured (MS) rounded periphery containers of the present invention may comprise an imprint in any location or component of the container such that it does not affect the ability of the container to perform its intended function. In particular embodiments, the imprinting may be printed upon, or the material may be printed upon before imprinting occurs.

In certain embodiments of the present invention, memory-structured (MS) rounded periphery container further comprises printed graphics, e.g., distortion control printed graphics. Distortion control printing, or distortion printing is the process of printing a distorted version of an image onto a sheet of plastic and systematically vacuum forming the sheet on a mold so that specific areas of the printed image appear in intended corresponding areas of the resulting three-dimensional finished product. In particular embodiments, the printed graphics comprise 2 or more colors. In particular embodiments, the printed graphics comprise 3 or more colors. In certain embodiments, the printing may be on the upper surface (product facing) of the storage cavity, the lower surface (underside that faces away from the product) of the storage cavity, or a combination of both.

Moreover, in certain embodiments, the memory-structured (MS) rounded periphery containers of the present invention may incorporate additional design elements that do not significantly inhibit or prevent the features of the containers explicitly described herein.

### A. Storage Cavity

The memory-structured (MS) rounded periphery containers of the present invention comprise a storage cavity defined by a concave base portion. The storage cavity of the memory-structured (MS) rounded periphery containers of the present invention serve as the lower portion of the container, i.e., the portion of the container on which the items stored in the container are placed. In certain embodiments comprising a cover portion, the storage cavity is the portion of the container with which the cover portion mates or interlocks. In certain other embodiments, the memory-structured (MS) rounded periphery container is an open container configuration, comprising only the base storage cavity (i.e., no cover portion). In certain embodiments, the storage cavity is shaped as a tray or bowl, e.g., single or multi compartment.

In certain embodiments of the present invention, the concave base portion is a tray base encircled by sidewalls forming the storage cavity.

In certain embodiments of the present invention, the upper portion (i.e., furthest from the tray base) of the sidewalls forms a rim. In certain embodiments, the rim is a flattened rim. In particular embodiments, the flattened rim forms a substantially planar sealing surface being suitable for sealing a sealing film thereto using either vacuum sealing or modified atmosphere sealing.

In certain embodiments of the storage cavities of the present invention, the rim comprises a return lip.

In certain embodiments of the present invention, the storage cavity further comprises liquid drain capture dimples, i.e., wherein the tray bottom comprises a textured surface to collect liquid. In certain embodiments, the containers comprise a textured surface to collect and/or retain liquid (e.g., meat juices).

In certain embodiments of the present invention, the memory-structured (MS) rounded periphery container further comprises an imprinting zone, e.g., a central imprinting zone.

In certain embodiments of the present invention, the volume capacity of the storage cavity compartment is not limited. In certain embodiments of the present invention, the volume capacity of the storage cavity compartment is selected from 2 US fluid ounces to 64 US fluid ounces, wherein such volume is defined by the side walls and tray base (e.g., wherein the volume size measurements are based on an industry standard “fill line” in fluid ounces). In certain specific embodiments, the dimensions of the storage cavity range from 0.5 inches by 1.5 inches by 1.5 inches to 6.0 inches by 14.0 inches by 14.0 inches. In certain specific embodiments, the dimensions of the storage cavity range from length 4″-15″ by width 4″-15″ by depth 1″-5″.

In certain embodiments of the invention, the storage cavity further comprises an optimized surface, e.g., sidewall or top surface, engineered for maximum labeling compatibility.

In certain embodiments of the present invention, the storage cavity further comprises printing, e.g., distortion control printed graphics. In particular embodiments, the printed graphics comprise 2 or more colors. In particular embodiments, the printed graphics comprise 3 or more colors. In certain embodiments, the printing may be on the upper surface (product facing) of the storage cavity, the lower surface (underside that faces away from the product) of the storage cavity, or a combination of both.

In certain embodiments of the present invention, the storage cavity further comprises a return wall engineered to improve structural integrity, e.g., present along the entire outer periphery of the storage cavity.

In certain embodiments of the present invention, the storage cavity further comprises a support ridge suitable to increase resistance to the tendency of the concave base portion to close upon itself, i.e., increasing hoop strength (e.g., wherein the support ridge is vertically positioned on the sidewall or horizontally positioned on the sidewall). In certain embodiments, the support ridge is positioned on the corners of the container.

In certain embodiments of the present invention, the storage cavity further comprises one or more scallop ridges, i.e., for increasing hoop strength. In certain embodiments, the scallop ridges are added to the corners of the storage cavity.

In certain embodiments of the present invention, the storage cavity further comprises at least one chamfered corner, e.g., at the bottom perimeter of the base portion, engineered to improve material distribution.

In certain embodiments of the invention, the storage cavity is comprised of plastic, e.g., clear/see-through or opaque plastic.

In certain embodiments of the invention, the storage cavity is designed to be clear for ease of view of the containment area, e.g., PETE.

### B. Memory-Structured Elbow

Moreover, it is the inclusion of the memory-structured elbow in the containers of the present invention positioned between a container rim and a peripheral flange such that the shape of the memory-structured elbow in combination with the deflected peripheral flange that produces a rounded periphery of the container. This memory-structured elbow in combination with the deflected peripheral flange reduces damage capability of the peripheral edge of the container. Moreover, the reduction in damage includes, but is not limited to reduction in tears, cuts, or rips in flesh or film.

In certain embodiments of the present invention, the periphery formed by the memory-structured elbow in combination with the deflected peripheral flange that produces a rounded peripheral edge of the container that shows increased strength, e.g., rigidity, as compared with existing containers that are reflected inward toward he sidewall and away from the periphery.

In certain embodiments of the present invention, the memory-structured elbow comprises a substantially vertical portion joined to the peripheral flange creating the acute angle presented peripherally.

In certain embodiments of the present invention, the substantially vertical portion of the memory-structured elbow descends from a return lip of the container rim.

In certain embodiments of the present invention, the acute angle is about 65 to 80 degrees. In certain alternate embodiments, the angle is not acute, e.g., 90 degrees.

In certain embodiments of the present invention, the peripheral flange extends from the memory-structured elbow to a length ranging from about 0.05 inches to about 0.175 inches, e.g., from about 0.07 inches to about 0.16 inches, e.g., about 0.10 inches.

### III. Methods of the Invention

The memory-structured (MS) rounded periphery containers of the present invention are made possible by the methods of the present invention, including methods of memory-structured peripheral edge rounding of a peripheral edge of a container, and methods of reducing damage to a film seal of a film sealed container.

As such, another embodiment of the present invention provides a method of a memory-structured peripheral edge rounding of a peripheral edge of a container comprising the step of
molding a storage cavity defined by a concave base portion comprising a memory-structured elbow with an acute angle presented peripherally is positioned between a container rim and a peripheral flange;
deflecting the peripheral edge of the peripheral flange of the storage cavity toward the periphery of the storage cavity,
   such that the shape of the memory-structured elbow in combination with the deflected peripheral flange produces a rounded periphery of the container. In certain embodiments of the present invention, the method produces a memory-structured (MS) rounded periphery container of the present invention.

Yet another embodiment of the present invention provides a method of reducing damage to a film seal of a film sealed container comprising the steps of
molding a storage cavity defined by a concave base portion comprising a memory-structured elbow with an acute angle presented peripherally is positioned between a container rim and a peripheral flange;
deflecting the peripheral edge of the peripheral flange of the storage cavity toward the periphery of the storage cavity, such that the shape of the memory-structured elbow in combination with the deflected peripheral flange produces a rounded periphery of the container; and
applying a film seal to the container (e.g., by overwrapping, vacuum-sealing, or in modified atmosphere). In certain embodiments of the present invention, the method produces a film sealed memory-structured (MS) rounded periphery container of the present invention.

In certain embodiments of the present invention, the film seal is applied by: sealing a film seal sheet to the sealing surface to form the sealed compartment through adhesive. In certain embodiments, the film seal sheet is trimmed peripherally about the sealing surface after it is sealed to the sealing surface.

In certain embodiments of the present invention, the film seal is applied by: sealing a film seal sheet to the sealing surface to form the sealed compartment using heat to heat-seal the film seal sheet to the sealing surface. In certain embodiments, the film seal sheet is trimmed peripherally about the sealing surface after it is sealed to the sealing surface.

In certain embodiments of the present invention, damage to the film seal resulting from the peripheral edge is reduced. In particular embodiments, damage to the film seal resulting from the peripheral edge is substantially reduced. In specific embodiments, damage to the film seal resulting from the peripheral edge is eliminated.

In certain embodiments of the present invention, the peripheral edge of the peripheral flange is deflected by contacting the peripheral edge with a molding ram.

In certain embodiments of the present invention, the peripheral edge of the peripheral flange is deflected using heat (e.g., a heated molding ram).

### A. Methods of Preparation

It should be readily understood by the ordinarily skilled artisan in light of the disclosure provided herein that a container constructed in accordance with the present invention can be manufactured in a variety of shapes and sizes, and can be formed from resins or plastic materials such as polyethylene, polypropylene, polyvinyl chloride or polyethylene terephthalate (“PETE”), as well as other suitable materials or combinations thereof. Moreover, the forming process can also vary to include methods such as thermoforming, injection molding or blow molding. In certain embodiments, the container can be transparent, translucent, or opaque, and may be colored in any instance.

In certain embodiments, and by no means intended to limit the memory-structured (MS) rounded periphery containers of the present invention in terms of design or construction, e.g., material composition, the memory-structured (MS) rounded periphery containers of the present invention are prepared by using thermoforming techniques/technology, in conjunction with a mold constructed to produce memory-structured (MS) rounded periphery containers of the present invention.

In general, thermoforming is a manufacturing process where a plastic sheet is heated to a forming-temperature as to be pliable, formed with a mold into a specific shape, and trimmed to create a usable product. The sheet is heated in an oven to a high-enough temperature that it can be stretched into or onto a mold and cooled to a finished shape. In certain embodiments, the process may be automated, for example, by using large production machines to heat and form the plastic sheet, as well as trim the formed parts from the sheet using a continuous process.

In particular embodiments, a plastic sheet may be fed from a roll or from an extruder into a set of indexing chains that incorporate pins, or spikes, which pierce the sheet and transport it through an oven for heating to forming-temperature. The heated sheet then moves through another station, i.e., a form station, where, with the application of vacuum, a mold and pressure-box close on the sheet to produce the desired product, e.g., the containers of the present invention. The sheet containing the formed product is then trimmed, e.g., with a die that cuts the product from the remaining sheet web.

In certain embodiments of the invention, the memory-structured (MS) rounded periphery containers are prepared from a single thermoform plastic sheet.

Accordingly, another embodiment of the present invention provides a mold for a memory-structured (MS) rounded periphery container comprising
an inverse structure designed to form a storage cavity defined by a concave base portion (e.g., a tray or bowl) through vacuum application to heated thermoplastic, e.g., a thermoplastic sheet, wherein the inverse structure is designed for the creation of the memory-structured elbow with an acute angle presented peripherally positioned between a container rim and a peripheral flange.

In certain embodiments of the present invention, the mold produces a memory-structured (MS) rounded periphery container of the present invention, i.e., the starting container formed may be deflectable inn accordance with the present invention (i.e., with a memory-structured elbow).

In certain embodiments, the molds used in these processes may be comprised of wood, composite, or aluminum.

It should be further understood that part of the thermoform process includes molds that create score lines or perforations. The ordinarily skilled artisan understand the processes that make these frangible or non-frangible, which are well known in the art.

### IV. Design Aspects of the Invention

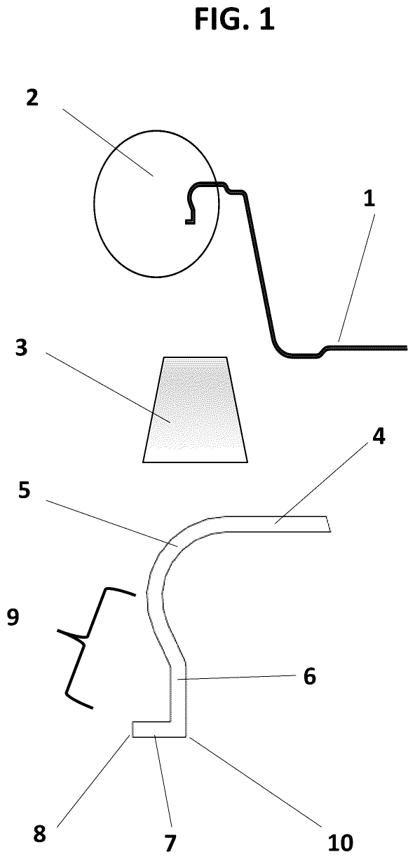

Independent of the utility related to the memory-structured (MS) rounded periphery containers and molds of the present invention, the ornamental appearance of any novel design provided herein is intended to be part of this invention, for example, each of the perspective views in FIGS. 1 through 11, which may form an independent or combined ornamental appearance of the memory-structured (MS) rounded periphery containers and related molds described herein.

Accordingly, one embodiment of the present invention provides a memory-structured (MS) rounded periphery container, and related molds, as shown and described. Another embodiment provides a film sealed container, and related molds, as shown and described.

### Exemplification

Having thus described the invention in general terms, reference will now be made to the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the following description or illustrated in the Figures. The invention is capable of other embodiments and of being practiced and carried out in various ways. Also, it is to be understood that the phraseology and terminology employed herein are for the purpose of description and should not be regarded as limiting.

FIG. 1 is a side cross-sectional view of half of a storage cavity 1 defined by a concave base portion. A section (circled) of the storage cavity 1 is expanded 3 and the components of that section more clearly described. The expanded view of the highlighted circle region 2 depicts a memory-structured elbow 9 with an acute angle (depicted as just under 90 degrees) presented peripherally is positioned between a container rim 4 and a peripheral flange 7. In particular, the memory-structured elbow 9 comprises a substantially vertical portion 6 joined to the peripheral flange 7 creating the acute angle presented peripherally. The substantially vertical portion 6 the memory-structured elbow 9 descends from a return lip 5 of the container rim 4, (e.g., a flattened container rim). Moreover, the peripheral edge 8 of the peripheral flange is shown along with the corner point 10 of the memory-structured elbow 9, where the substantially vertical portion 6 and the peripheral flange 7 intersect.

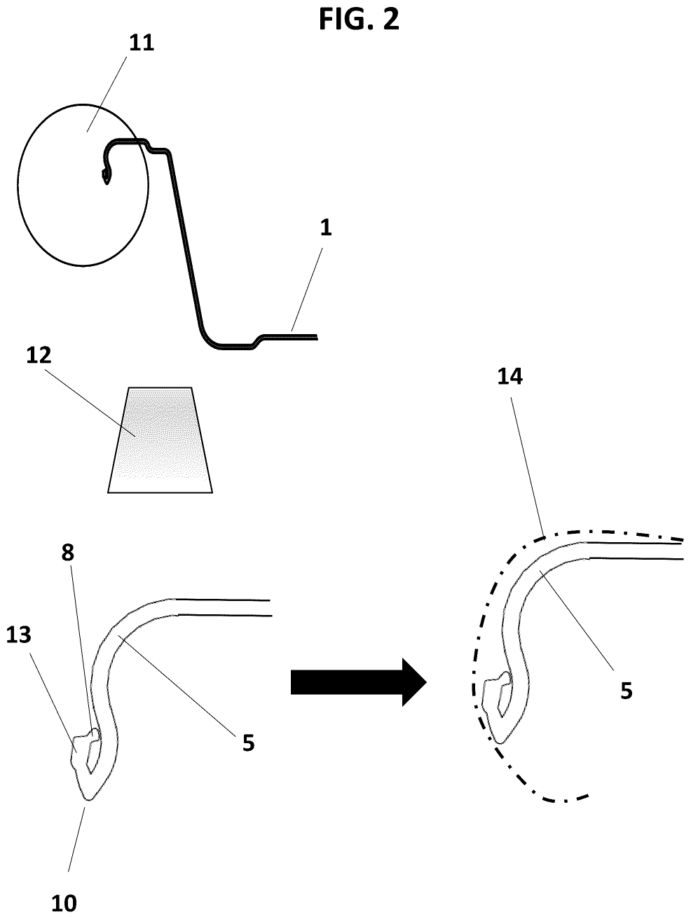

FIG. 2 is a side cross-sectional view of half of the storage cavity 1 of FIG. 1, wherein the peripheral edge 8 of the peripheral flange 7 is deflected toward the periphery of the storage cavity 1, and the shape of the memory-structured elbow 9 in combination with the deflected peripheral flange 7 produces a rounded periphery of the memory-structured (MS) rounded periphery containers. A section of the storage cavity 1 is expanded 12 and the components of that section more clearly described. The expanded view of the highlighted circle region 11 is also shown with and without film seal wrapping 14, detailing memory-structured elbow 9 in combination with the deflected peripheral flange that produces a rounded periphery of the container. For reference, the return lip 5 is shown, along with the manipulated/deflected peripheral flange 7 (shown in FIG. 2 as manipulated peripheral flange 13), and depicted with corner point 10 and peripheral edge 8.

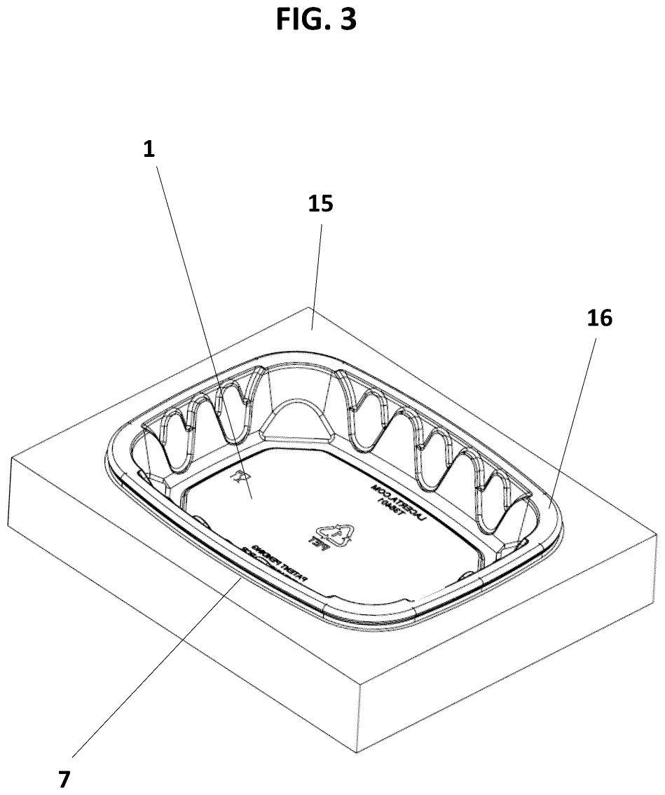

FIG. 3 is a top view perspective of an exemplary storage cavity 1 positioned inside a mold 15 used to create it, defined by a concave base portion and wherein a memory-structured elbow with an acute angle presented peripherally is positioned between the flattened container rim 16 and a peripheral flange 7.

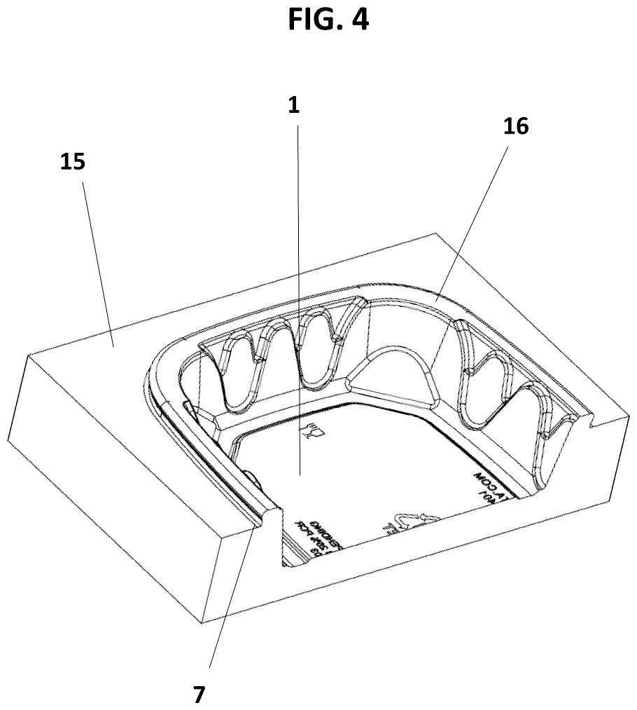

FIG. 4 is a cross-sectional view of FIG. 3, of an exemplary storage cavity 1 positioned inside a mold 15 used to create it, defined by a concave base portion and wherein a memory-structured elbow with an acute angle presented peripherally is positioned between the flattened container rim 16 and a peripheral flange 7.

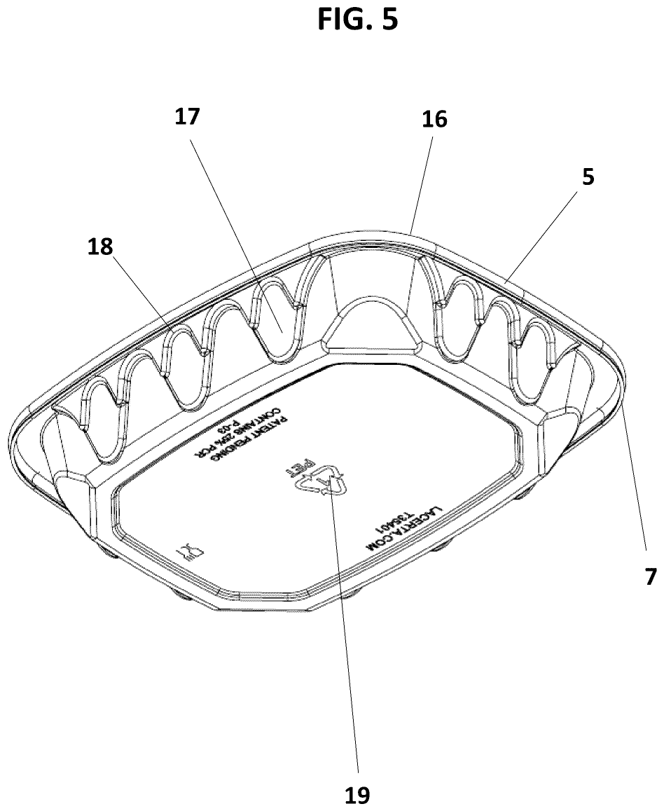

FIG. 5 is bottom view perspective of the storage cavity 1 shown in FIG. 3 (as inside the mold 15). The concave base portion defining the storage cavity 1 is a tray base 19, shown with multiple imprinting zones, encircled by sidewalls 17 forming the storage cavity 1. Sidewalls 17 are shown with support ridge 18, depicted to show the upper portion forms flattened container rim 16. For convenience, the return lip 5, and the peripheral flange 7 are also shown.

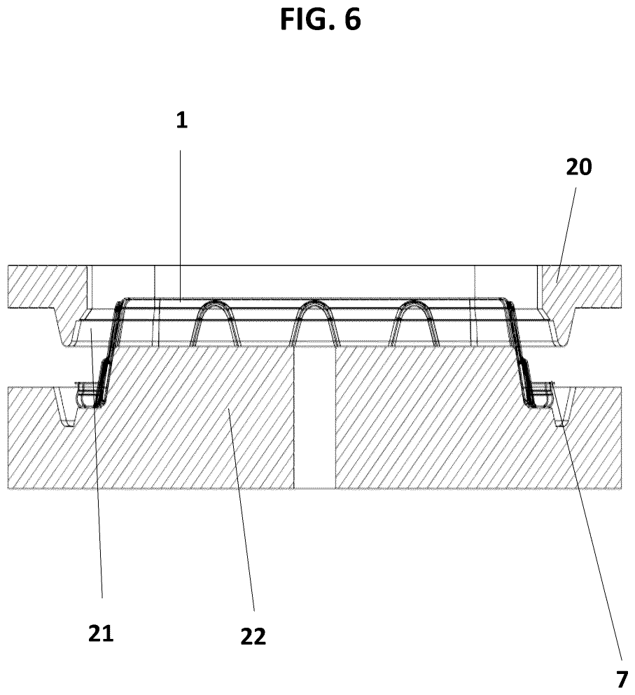

FIG. 6 is a cross-sectional view of the storage cavity 1 of FIG. 3 positioned inside the molding ram 20 used for deflecting the peripheral edge 8 of the peripheral flange 7 of the storage cavity 1 toward the periphery of the storage cavity 1 to produce a memory-structured (MS) rounded periphery container of the present invention. The storage cavity 1 is placed on receiving mold 22 that contains a complementary surface to the shaped molding surface 21 of molding ram 20.

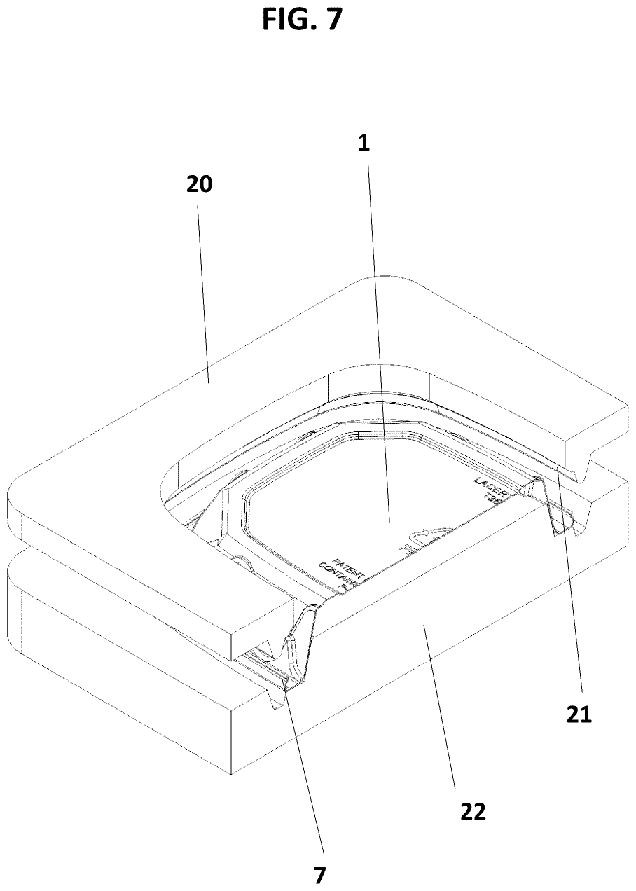

FIG. 7 is a top down cross-sectional view of FIG. 6, showing the storage cavity 1 of FIG. 3 positioned inside the molding ram 20 used for deflecting the peripheral edge 8 of the peripheral flange 7 of the storage cavity 1 toward the periphery of the storage cavity 1 to produce a memory-structured (MS) rounded periphery container of the present invention. The storage cavity 1 is placed on receiving mold 22 that contains a complementary surface to the shaped molding surface 21 of molding ram 20.

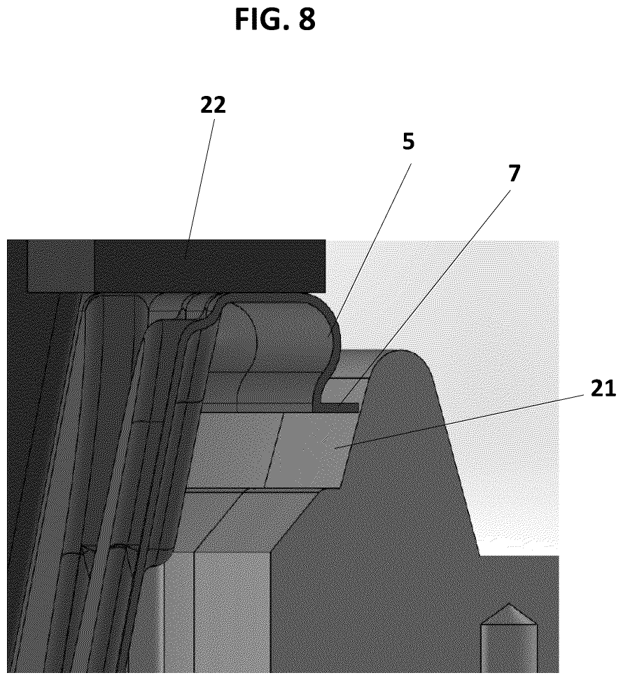

FIG. 8 is close-up side angle perspective (flipped upside down from FIGS. 6 and 7) to show the initial positioning of the angled/shaped molding ram surface 21 of molding ram 20 against the peripheral edge 8 of the peripheral flange 7 of the storage cavity 1 of FIG. 6, placed on receiving mold 22. For additional reference, return lip 5 is shown.

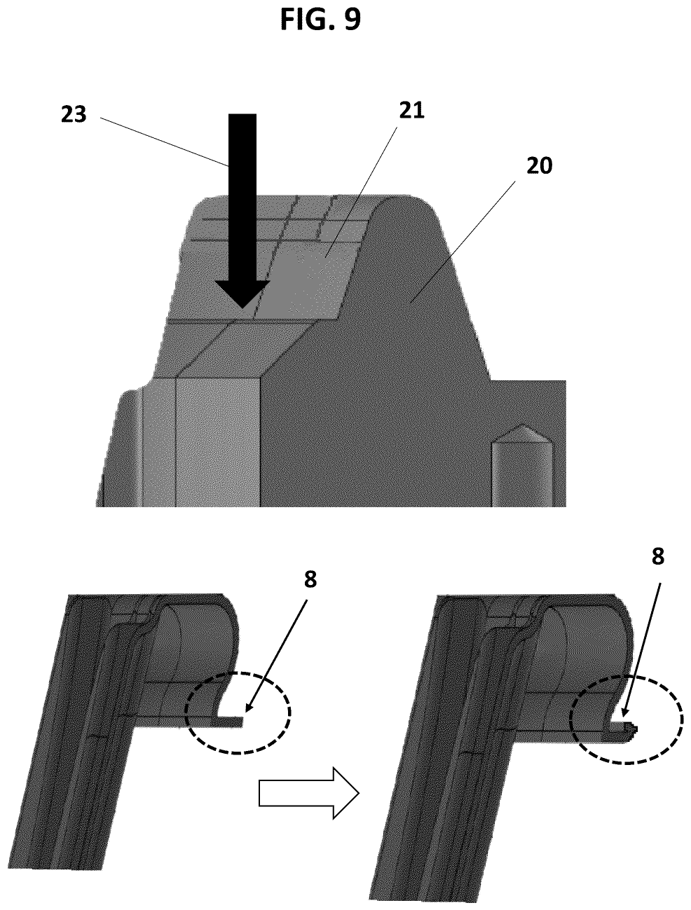

FIG. 9 shows the molding ram surface 21 of molding ram 20 depicted in FIG. 8, removed and highlighted on its own to assist in visualizing the movement of storage cavity 1 down/into the first sloped section of molding ram surface 21 and the transition of the peripheral edge 8 of the peripheral flange 7 that strikes the heated molding ram 20 and turns the peripheral edge 8 upwards. For reference, the movement/deflection/manipulation of the peripheral edge 8 is shown within the dashed circle highlighted area.

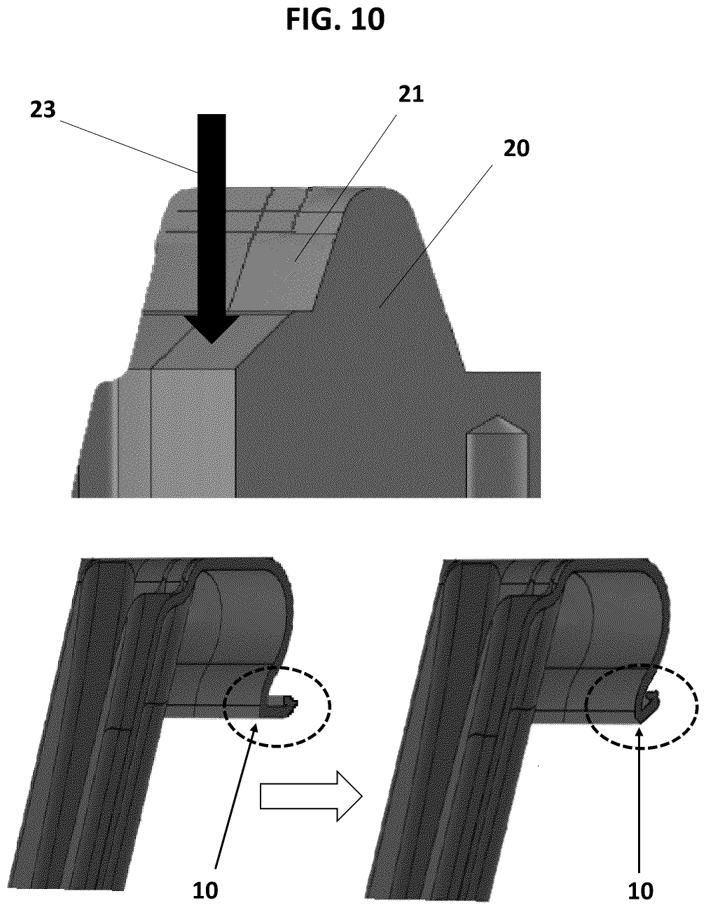

FIG. 10 shows the molding ram surface 21 of molding ram 20 depicted in FIGS. 8 and 9, removed and highlighted on its own to assist in visualizing the movement of storage cavity 1 down/into the horizontal and second sloped sections of molding ram surface 21, and the transition of another section of the peripheral flange 7 deflected peripherally, which simultaneously and consequently turns the upward peripheral edge 8 inward, such that the shape of the deflected memory-structured elbow 9 in combination with the manipulated/deflected peripheral flange 7 (also shown in FIG. 2 as deflected peripheral flange 13) produces a rounded periphery of the container. For reference, the movement of the corner point 10 of the memory-structured elbow 9 is shown within the dashed circle highlighted area.

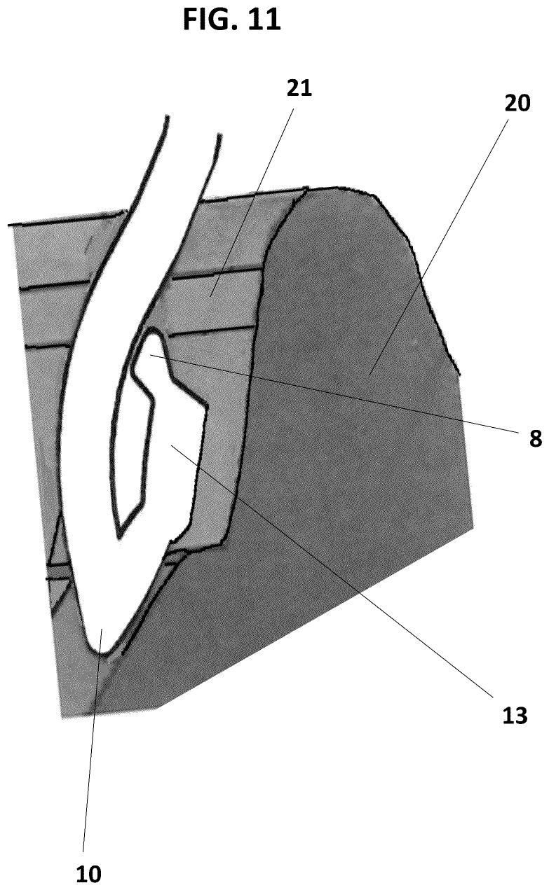

FIG. 11 shows a side cross-section angle of the dashed circle highlighted area in FIG. 10 (right side dashed circle) of the deflected peripheral flange 13 superimposed on the molding ram surface 21 in its final position in molding ram 20, wherein the peripheral edge 8 of the manipulated/deflected peripheral flange 7 has been deflected toward the periphery of the storage cavity 1, and the shape of the memory-structured elbow 9 in combination with the deflected peripheral flange 13 produces a rounded periphery of the memory-structured (MS) rounded periphery containers.

### Incorporation by Reference

The entire contents of all patents, published patent applications and other references cited herein are hereby expressly incorporated herein in their entireties by reference.

### Equivalents

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A memory-structured (MS) rounded periphery container comprising
a storage cavity defined by a concave base portion,
wherein a memory-structured elbow with an acute angle presented peripherally is positioned between a container rim and a peripheral flange, wherein the peripheral edge of the peripheral flange is deflected toward the periphery of the storage cavity, and the shape of the memory-structured elbow in combination with the deflected peripheral flange produces a rounded periphery of the container.

2. The memory-structured (MS) rounded periphery container of claim 1, wherein the memory-structured elbow comprises a substantially vertical portion joined to the peripheral flange creating the acute angle presented peripherally.

3. The memory-structured (MS) rounded periphery container of claim 1, wherein the substantially vertical portion of the memory-structured elbow descends from a return lip of the container rim.

4. The memory-structured (MS) rounded periphery container of claim 1, wherein the acute angle is about 65 to 80 degrees.

5. The memory-structured (MS) rounded periphery container of claim 1, is a film sealed container further comprising a film seal used for sealing the container.

6. The memory-structured (MS) rounded periphery container of claim 5, wherein damage to the film seal resulting from the peripheral edge is reduced.

7. The memory-structured (MS) rounded periphery container of claim 5, wherein the MS rounded periphery container is selected from the group consisting or an overwrap container, a vacuum-sealed container, and a modified atmosphere container.

8. The memory-structured (MS) rounded periphery container of claim 1, wherein the concave base portion is a tray base encircled by sidewalls forming the storage cavity.

9. The memory-structured (MS) rounded periphery container of claim 1, wherein the upper portion of the sidewalls forms the rim.

10. The memory-structured (MS) rounded periphery container of claim 1, wherein the rim is a flattened rim.

11. The memory-structured (MS) rounded periphery container of claim 10, wherein the flattened rim forms a substantially planar sealing surface being suitable for sealing a sealing film thereto using either vacuum sealing or modified atmosphere sealing.

12. The memory-structured (MS) rounded periphery container of claim 1, wherein the rim comprises a return lip.

13. The memory-structured (MS) rounded periphery container of claim 1, wherein the MS rounded periphery container is formed from thermoplastic.

14. The memory-structured (MS) rounded periphery container of claim 1, wherein the peripheral flange extends from the memory-structured elbow to a length ranging from about 0.05 inches to about 0.175 inches.

15. The memory-structured (MS) rounded periphery container of claim 1, further comprising a support ridge suitable to increase resistance to the tendency of the concave base portion to close upon itself.

16. The memory-structured (MS) rounded periphery container of claim 1, further comprising liquid drain capture dimples.

17. The memory-structured (MS) rounded periphery container of claim 1, further comprising an imprinting zone.

18. A method of memory-structured peripheral edge rounding of a peripheral edge of a container comprising the steps of:
molding a storage cavity defined by a concave base portion comprising a memory-structured elbow with an acute angle presented peripherally is positioned between a container rim and a peripheral flange;
deflecting the peripheral edge of the peripheral flange of the storage cavity toward the periphery of the storage cavity,
such that the shape of the memory-structured elbow in combination with the deflected peripheral flange produces a rounded periphery of the container.

19. The method of claim 18, wherein the peripheral edge of the peripheral flange is deflected by contacting the peripheral edge with a molding ram.

20. The method of claim 18, wherein the peripheral edge of the peripheral flange is deflected using heat.

21. The method of claim 18, wherein the method produces a memory-structured (MS) rounded periphery container of claim 1.

22. A film sealed container comprising
a memory-structured (MS) rounded periphery container of claim 1; and
a film seal.
